(19) United States
(12) Patent Application Publication
(10) Pub. No.: US 2011/0039453 A1
(43) Pub. Date: Feb. 17, 2011

(54) Electric Plug Device For Extending And Replacing A Malfunctioning Female Power Outlet

(76) Inventor: Angelo Gencarelli, Nutley, NJ (US)

Correspondence Address: Ashok Tankha, 36 Greenleigh Drive, Sewell, NJ, 08080, US

(21) Appl. No.: 12/269,038

(22) Filed: Nov. 12, 2008

(51) Int. Cl. H01R 25/00

(52) U.S. Cl. 439/652

(57) ABSTRACT

Disclosed herein is an electric plug device and a method for extending and replacing a malfunctioning power outlet. The electric plug device comprises a mains plug, an extension cable, and a power extender. The mains plug comprises a male power inlet and multiple first female power outlets. The male power inlet is electrically connected to the first female power outlets. The male power inlet provides an electrical input pathway. The first female power outlets provide multiple electrical output pathways. The malfunctioning power outlet may be one of the first female power outlets. The extension cable electrically connects the malfunctioning power outlet to the power extender. The power extender comprises multiple second female power outlets. The malfunctioning power outlet is connected to the second female power outlets by the extension cable. The extension cable and the power extender enable the extension and the replacement of the malfunctioning power outlet respectively.

### BACKGROUND

This invention, in general, relates to power strips. More particularly, this invention relates to an electric plug device for extending and replacing a malfunctioning power outlet.

An electric plug device, for example, a power strip is a strip of electrical outlets that attaches to the end of a flexible cable and allows multiple devices to be plugged in. A power strip is typically used for connecting multiple electrical devices into a single power outlet. A user may need to connect multiple electrical devices into the single power outlet locally or distally from the single power outlet. Moreover, the user may need to extend multiple power outlets to accommodate one or more distally located devices. Furthermore, one of the multiple power outlets may be malfunctioning and unusable. Therefore, it may be inconvenient for the user to connect multiple devices to the malfunctioning power outlets. It may also be difficult for the user to replace the malfunctioning power outlets. The replacement may be laborious and may require a technician. Furthermore, the malfunctioning power outlet requires replacement with a new power outlet which may be expensive.

Hence, there is an unmet need for an electric plug device and method that extends and replaces a malfunctioning power outlet.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The electric plug device disclosed herein addresses the above stated need for extending and replacing a malfunctioning power outlet. The electric plug device disclosed herein comprises a mains plug, an extension cable, and a power extender. The mains plug comprises a male power inlet for providing an electrical input pathway. The male power inlet comprises pins or blades that connect mechanically or electrically to holes in an external power outlet. The mains plug further comprises multiple first female power outlets. The first female power outlets comprise holes or slots and accept pins or blades of an electric device. The male power inlet is electrically connected to the first female power outlets. The first female power outlets provide multiple electrical output pathways. The male power inlet and the first female power outlets are embedded in a first insulating case. The mains plug comprises a first insulating case for embedding the male power inlet and the first female power outlets. The first insulating case is provisioned for connecting the first end of the extension cable to the malfunctioning power outlet through a first wire inlet.

The malfunctioning power outlet may be one of the first female power outlets. The extension cable is provided for electrically connecting the malfunctioning power outlet to the power extender. The extension cable comprises a first end and a second end. The power extender comprises multiple second female power outlets for providing multiple electrical output pathways. The second female power outlets comprise holes or slots and accept pins or blades of an electric device. The malfunctioning power outlet is connected to the second female power outlets by the extension cable. The power extender comprises a second insulating case for embedding the second female power outlets. The second insulating case is provisioned for connecting the second end of the extension cable to the second female power outlets through a second wire inlet.

Multiple screws are provided for opening and closing the first insulting case and the second insulating case to connect the extension cable due to malfunctioning of one of the first female power outlets. The extension cable is a flexible electrical cable of a predefined length. The first end of the extension cable is connected to the malfunctioning power outlet through the first wire inlet. The second end of the extension cable is connected to the second female power outlets through a second wire inlet. The first insulating case and the second insulation case are made of a material that resists electric current flow and provides safety from electric shock hazards. The extension cable and the power extender comprising the second female power outlets enable extension and replacement of the malfunctioning first power outlets respectively.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein

FIG. 1 exemplarily illustrates an electric plug device for extending and replacing a malfunctioning power outlet.

FIG. 2 exemplarily illustrates a mains plug comprising a first insulating case embedded with a male power inlet and first power outlets.

FIG. 3 exemplarily illustrates an extension cable connected to a power extender comprising a second insulating case embedded with second female power outlets.

FIG. 4 illustrates a method of extending and replacing a malfunctioning power outlet.

### DETAILED DESCRIPTION OF THE INVENTION

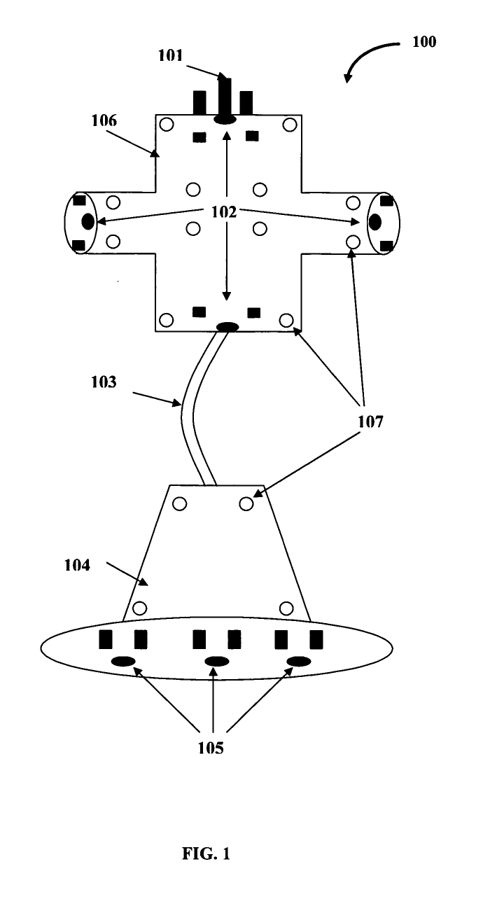

FIG. 1 illustrates an electric plug device 100 for extending and replacing a malfunctioning power outlet. The electric plug device 100 may be referred to as a power strip that extends and replaces the malfunctioning power outlet. The malfunctioning power outlet may, for example, be present on an existing extension cord. The electric plug device 100 comprises a mains plug 200, an extension cable 103, and a power extender 300. The mains plug 200 comprises a male power inlet 101 and two or more of multiple first female power outlets 102. The male power inlet 101 provides an electrical input pathway. The male power inlet 101 is electrically connected to the first female power outlets 102. The first female power outlets 102 provide electrical output pathways. The mains plug 200 further comprises a first insulating case 106 for embedding the male power inlet 101 and the first female power outlets 102. The mains plug 200 comprises a first insulating case 106 for embedding the male power inlet 101 and the first female power outlets 102.

The electric plug device 100 may, for example, have a voltage rating of 110 volts. The voltage rating may be increased to 220 volts by replacing the male power inlet 101 and the first female power outlets 102 with another male power inlet and power outlets respectively based on predefined electrical codes. The electric plug device 100 may be plugged into an external power outlet.

The extension cable 103 comprises a first end and a second end. The first end of the extension cable 103 is connected to the malfunctioning power outlet through a first wire inlet 201. The second end of the extension cable 103 is connected to the power extender 300 through a second wire inlet 301. The power extender 300 comprises multiple second female power outlets 105. The power extender 300 further comprises a second insulating case 104 for embedding the second female power outlets 105. Instead of the extension cable 103, multiple wires may be used to connect the power extender 300 to the malfunctioning power outlet of the mains plug 200 through a second wire inlet 301 and a first wire inlet 201 respectively. The multiple wires, therefore, enable replacement of the malfunctioning power outlet with the second female power outlets 105. Two or more extension cables may be provided for providing two or more sets of second female power outlets 105 to replace the malfunctioning power outlet.

Multiple screws 107 are provided for opening and closing the first insulting case 106 and the second insulating case 104 when the extension cable 103 needs to be connected due to malfunctioning of one or more of the first female power outlets 102. For purposes of illustration, the detailed description refers to a single extension cable 103 and a single malfunctioning power outlet; however the scope of the electric plug device 100 and method disclosed herein is not limited to a single extension cable 103 and a single malfunctioning power outlet but may be extended to include multiple extension cables and multiple malfunctioning power outlets.

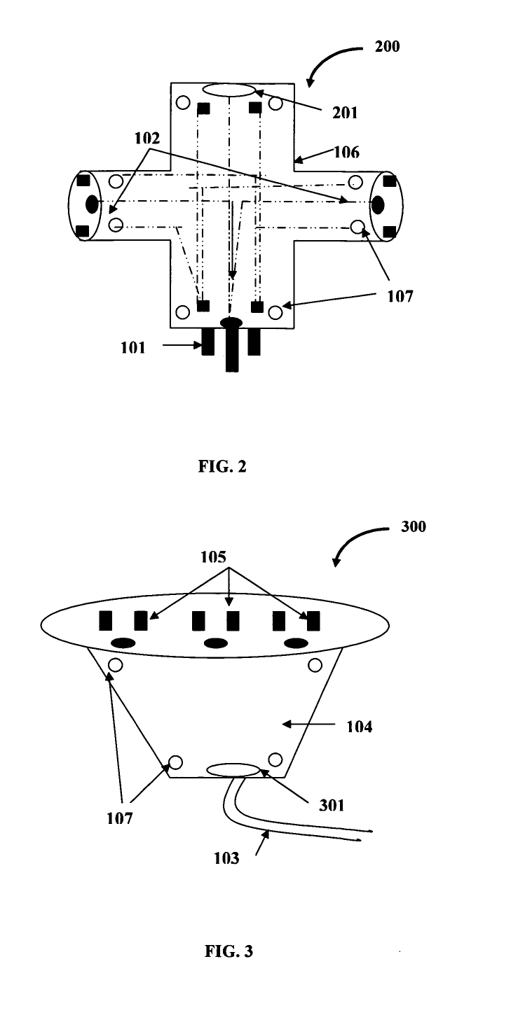

FIG. 2 exemplarily illustrates a mains plug 200 comprising a first insulating case 106 embedded with a male power inlet 101 and four first female power outlets 102. The mains plug 200 may, for example, be used to repair one or more existing power outlets. The male power inlet 101 is a male electrical connector. The male power inlet 101 provides an electrical input pathway. The male power inlet 101 comprises pins or blades that connect mechanically or electrically to holes in an external power outlet. The male power inlet 101 is electrically connected to the first female power outlets 102. In FIG. 2, the male power inlet 101 is electrically connected to four first female power outlets 102. The first female power outlets 102 provide multiple electrical output pathways. The first female power outlets 102 comprise holes or slots and accept pins or blades of an electric device. The first female power outlets 102 are female electrical connectors. The electric plug device 100 therefore is a male electrical connector with integrated female electrical connectors.

The male power inlet 101 and the first female power outlets 102 are embedded in the first insulating case 106. The first insulating case 106 is provisioned for connecting the first end of the extension cable 103 to a malfunctioning power outlet through a first wire inlet 201. The malfunctioning power outlet may be one of the first female power outlets 102. Multiple screws 107 may be provided for opening and closing the first insulting case 106 to connect the first end of the extension cable 103 to the malfunctioning power outlet through the first wire inlet 201. The first insulating case 106 may, for example, be in the shape of a cross with the first female power outlets 102 present at the four corners of the cross shaped first insulating case 106.

The initial disclosure illustrated the wires in FIG. 2 connected between the male power inlet and the first female power outlets whereas in the updated drawings the wires are connected between the first female power outlets. Please state where the wires are to be connected.

In FIG. 2, internal wires used as the electrical connections between the male power inlet 101 and the first female power outlets 102 are exemplarily indicated by dashed lines. The internal wires provide a ground contact and a live contact for the male power inlet 101 and the first female power outlets 102. The first insulating case 106 is made of a material that resists electric current flow and provides protection from electric shock hazards. The material may, for example, be plastic, ceramic, glass, etc.

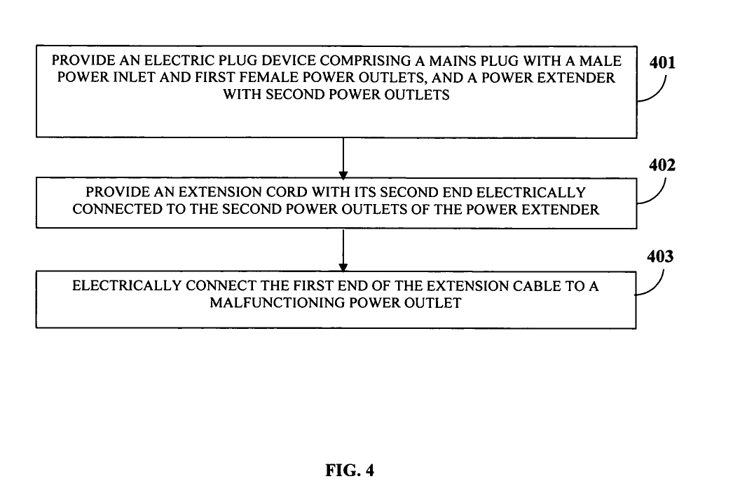

FIG. 3 exemplarily illustrates an extension cable 103 connected to a power extender comprising a second insulating case 104 embedded with second female power outlets 105. The power extender 300 may, for example, be used to repair an existing extension cord or make an extension cord with multiple second female power outlets 105. The second female power outlets 105 are embedded in the second insulating case 104. The second insulating case 104 is provisioned for connecting the second end of the extension cable 103 to the second female power outlets 105 through a second wire inlet 301. Multiple screws 107 are provided for opening and closing the second insulting case 104 to connect the second end of the extension cable 103 to the second female power outlets 105 through a second wire inlet 301. The second insulating case 104 may, for example, be in the shape of a cone with the second female power outlets 105 present at the base of the cone. The second insulating case 104 is made of a material that resists electric current flow and provides protection from electric shock hazards. The material may, for example, be plastic, ceramic, glass, etc.

The extension cable 103 connected to a second insulating case 104 allows replacement of the malfunctioning power outlet by the second female power outlets 105. The second female power outlets 105 provide multiple electrical output pathways. The second female power outlets 105 comprise holes or slots and accept pins or blades from external electrical appliances. The extension cable 103 is electrically connected to the second female power outlets 105 within the second insulating case 104. Internal wires may be used as the electrical connections between the extension cable 103 and the second female power outlets 105. The internal wires provide a ground contact and a live contact for the male power inlet 101, the extension cable 103, and the second female power outlets 105. The extension cable 103 is a flexible electrical cable of a predefined length. The extension cable 103 is unrolled in length and the first end is connected to the malfunctioning power outlet.

Multiple third female power outlets (not shown) may be laterally positioned on the mains plug 200 and the power extender 300 of the electric plug device 100. The third female power outlets provide additional electrical output pathways.

FIG. 4 illustrates a method of extending and replacing a malfunctioning power outlet. An electric plug device comprising a mains plug and a power extender is provided 401. The mains plug comprises a male power inlet and multiple first female power outlets. The male power inlet provides an electrical input pathway. The male power inlet is electrically connected to the first female power outlets within the first insulating case. The first female power outlets provide multiple electrical output pathways. The power extender comprises multiple second female power outlets for providing multiple electrical output pathways. An extension cable is provided 402. The extension cable comprises a first end and a second end. The second end of the extension cable is electrically connected to the second female power outlets of the power extender. The electrical connection enables flow of electric current from the first female power outlets to the second female power outlets. The first end of the extension cable is electrically connected 403 to the malfunctioning power outlet, thereby replacing the malfunctioning first power outlet with the second female power outlet's.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

I claim:

1. An electric plug device for extending and replacing a malfunctioning power outlet, comprising:
a mains plug comprising a male power inlet for providing an electrical input pathway, and a plurality of first female power outlets for providing a plurality of electrical output pathways, wherein said male power inlet is electrically connected to said first female power outlets;
an extension cable comprising a first end and a second end for electrically connecting said malfunctioning power outlet to a power extender, wherein the malfunctioning power outlet is one of the first female power outlets; and
said power extender comprising a plurality of second female power outlets for providing a plurality of electrical output pathways, wherein the malfunctioning power outlet is connected to said second female power outlets by said extension cable.

2. The electric plug device of claim 1, wherein said mains plug comprises a first insulating case for embedding the male power inlet and the first female power outlets.

3. The electric plug device of claim 2, wherein said first insulating case is provisioned for connecting the first end of the extension cable to the malfunctioning power outlet through a first wire inlet.

4. The electric plug device of claim 2, further comprising a plurality of screws for opening and closing said first insulting case to connect the first end of the extension cable to the malfunctioning power outlet through a first wire inlet.

5. The electric plug device of claim 1, wherein the power extender comprises a second insulating case for embedding the second female power outlets.

6. The electric plug device of claim 5, wherein said second insulating case is provisioned for connecting the second end of the extension cable to the second female power outlets through a second wire inlet.

7. The electric plug device of claim 5, further comprising a plurality of screws for opening and closing said second insulting case to connect the second end of the extension cable to the second female power outlets through a second wire inlet of the power extender.

8. An electric plug device for extending and replacing a malfunctioning power outlet, comprising:
a male power inlet for providing an electrical input pathway, wherein said male power inlet is electrically connected to a plurality of first female power outlets, wherein said first female power outlets provide a plurality of electrical output pathways;
an extension cable comprising a first end and a second end, wherein said extension cable electrically connects said malfunctioning power outlet to a plurality of second female power outlets, wherein the malfunctioning power outlet is one of the first female power outlets; and
said second female power outlets for providing a plurality of electrical output pathways;
whereby said extension cable and the second female power outlets enable said extension and said replacement of the malfunctioning power outlet respectively.

9. A method of extending and replacing a malfunctioning power outlet, comprising the steps of:
providing an electric plug device comprising:
a mains plug comprising a male power inlet for providing an electrical input pathway, and a plurality of first female power outlets for providing a plurality of electrical output pathways, wherein said male power inlet is electrically connected to said first female power outlets;
a power extender comprising a plurality of second female power outlets for providing a plurality of electrical output pathways;
providing an extension cable comprising a first end and a second end, wherein said second end of said extension cable is electrically connected to said second female power outlets of said power extender; and
electrically connecting said first end of the extension cable to said malfunctioning power outlet, wherein the malfunctioning power outlet is one of the first female outlets of said mains plug.

10. The method of claim 9, wherein the male power inlet and the first female power outlets of the mains plug are embedded in a first insulating case.

11. The method of claim 10, wherein said first insulating case is provisioned for connecting the first end of the extension cable to the malfunctioning power outlet through a first wire inlet.

12. The method of claim 10, wherein the electric plug device further comprises a plurality of screws for opening and closing said first insulating case to connect the first end of the extension cable to the malfunctioning power outlet through a first wire inlet.

13. The method of claim 9, wherein the second female power outlets of the power extender are embedded in a second insulating case.

14. The method of claim 13, wherein said second insulating case is provisioned for connecting the second end of the extension cable to the second female power outlets through a second wire inlet.

15. The method of claim 13, wherein the electric plug device further comprises a plurality of screws for opening and closing said second insulating case to connect the second end of the extension cable to the second female power outlets through a second wire inlet.
